(19) United States
(12) Patent Application Publication
(10) Pub. No.: US 2009/0026080 A1
(43) Pub. Date: Jan. 29, 2009

(54) APPARATUS AND METHOD FOR SEPARATING PARTICLES

(76) Inventors: Chang-Soo Han, Daejeon-city (KR); Ji-Eun Kim, Daejeon-city (KR)

Correspondence Address: KED & ASSOCIATES, LLP, P.O. Box 221200, Chantilly, VA, 20153-1200, US

(21) Appl. No.: 12/279,093

(22) PCT Filed: Feb. 16, 2007
(86) PCT No.: PCT/KR2007/000861

§ 371 Date: Aug. 12, 2008

(30) Foreign Application Priority Data
Feb. 17, 2006 (KR) 10-2006-0015650

(51) Int. Cl. B01D 57/02; B03C 5/02

(52) U.S. Cl. 204/545; 204/643; 204/547

(57) ABSTRACT

A particle separator for separating different types of particles with different properties includes a channel unit including a flow channel through which a first fluid having particles with at least one physical characteristic and a second fluid that flows near the first fluid, and a plurality of outflow channels that are connected to the flow channel and that separate the fluid having passed the flow channel; and a field forming unit, installed adjacent to the flow channel, for separating the particles included in the first fluid from the first fluid and generating a non-uniform field so that the particles may flow together with the second fluid.

### TECHNICAL FIELD

The present invention relates to a particle separator and a particle separating method. More particularly, the present invention relates to a particle separator for separating particles included in the fluid of mixed particles with different physical properties, and a particle separating method thereof.

### BACKGROUND ART

A particle separator separates different types of particles in a single fluid according to a physical or chemical method, and in detail, it separates the particles by using characteristics that a predetermined type of particles have when the particles included in the flowing fluid have different physical, chemical, or physiological characteristics.

The particles according to embodiment of the present invention include biochemical particles such as DNA, proteins, cells, enzymes, or antibodies, and organic/inorganic compounds such as carbon nanotubes, nanowire, metals, semiconductors, polymers, and chemical dopes, and the particles are defined to include anything that exists with a predetermined form in a single object or a chain manner in the fluid, and things that occupy predetermined space and have mass as components in nature.

In this instance, the physical properties includes various characteristics such as dielectric constant, polarity, ph, form, resistance, and capacitance, and power applied to the outside includes power caused by an electric field, a magnetic field, or an optical field.

It is very important to separate particles by desired properties when the particles having different physical properties are mixed, which has been studied.

For example, various diseases can be further easily diagnosed when red blood corpuscles and white blood corpuscles in blood plasma can be separated without damage, and it is very important to physiologically separate dead and living sperm from among sperm in biological processes such as cloning and cultivation.

As another example, a particle separator can be used for the field of separating carbon nanotubes (CNTs) having a physical property that is difficult to control in a physical chemical production process.

The carbon nanotube (CNT) is the representative material of the nanotube, and it was found by Dr. Ijima in Japan in the 1990's and is very actively studied for application in various fields as well as industry because of its excellent performance. The carbon nanotube has a thin and long tube form, and is classified as a single-walled nanotube (SWNT) having a single-layered wall and a multi-walled nanotube (MWNT) having a multi-layered wall.

In general, the diameter of the SWNT is less than 1 nm, that of the MWNT is given from 10 to 100 nm, and it is possible to make the diameter lesser or greater depending on the manufacturing conditions and method. The length of the nanotube is generally about several μm in the manufacturing process, and it was recently reported that nanotubes with lengths of several mm have been developed.

The carbon nanotube weighs less than aluminum, but is stronger than general iron by a factor of several tens, has a better current transmission property than copper, and has very strong resistance against chemical and physical conditions. Also, since the carbon nanotube has a wide surface area because of its tube form, other chemicals can be attached or fixed thereto, and hence the carbon nanotube is also being researched as a fuel cell.

The carbon nanotube imparts a semiconductor or metal property in a manufacturing process, and it is applicable to field-effect transistors (FETs), single electron transistors (SETs), and nanowire. The carbon nanotube generates electrons and X-rays when receiving a current, and it has been developed for field emission displays and lamps.

In addition, other applications for carbon nanotubes include chemical and biological sensors, composite materials, nano-memory, and nano-computers.

There are many problems to be solved in order to apply carbon nanotubes to the various fields of industry. One of the most important tasks is to manufacture carbon nanotubes having desired properties by controlling in advance the conditions in which the carbon nanotubes having different characteristics are manufactured in a mixed manner.

However, no methods for manufacturing carbon nanotubes with sufficient productivity have been developed. Therefore, many researchers have attempted to separate nanotubes with desired properties from among mixed nanotubes with various properties.

Recently, Krupke has shown the possibility of separating metallic nanotubes from semiconductor nanotubes by using dielectrophoresis and attaching metallic nanotubes to a desired electrode. Further, other experimental research has been progressed, but they have failed to propose productive methods for separating and gathering semiconductor nanotubes and metallic nanotubes required by the real fields of industry.

A conventional particle separator controls particles that are mixed in a fluid that is input to a channel having an inflow hole to be output to different outflow holes according to physical properties.

However, it is difficult for a particle separator to control the particles with different physical properties in the respective desired directions by using a single power.

That is, when particles are charged with a positive polarity and a negative polarity, they can be easily separated in an electric field, but when one particle is charged with a positive polarity and the other particle has no electrical attribute, it is very difficult to control the particles in the desired direction.

Therefore, the conventional device has a difficulty in separating particles having a predetermined property from a fluid having many types of particles.

Further, inorganic nano-particles such as silver and gold are separated by using a surfactant in order to solve the phenomenon of coagulation of the inorganic nano-particles, and in this instance, there is a great need to separate the manufactured nano-particles from the solution in which the surfactant is excessively included according to the viewpoint of industry.

To solve the problem, the nano-particles are separated by a centrifugal separator, but the amount to be separated per time is low and the corresponding productivity is low.

### DISCLOSURE

### Technical Problem

The present invention has been made in an effort to provide a particle separator for easily separating particles with a predetermined physical property from a fluid including particles with different physical properties, and a particle separating method thereof.

### Technical Solution

In one aspect of the present invention, a particle separator includes a channel unit including a flow channel through which a first fluid having particles with at least one physical characteristic and a second fluid that flows near the first fluid flow, and a plurality of outflow channels that are connected from the flow channel and separate the fluid having passed the flow channel; and a field forming unit, installed adjacent to the flow channel, for separating particles included in the first fluid from the first fluid and generating a non-uniform field so that the particles may flow together with the second fluid.

In another aspect of the present invention, a particle separating method includes: combining a first fluid including particles with at least one physical property and a second fluid that is communicated adjacent to the first fluid; generating a field for applying a physical force to the first fluid and the second fluid; separating the particles with the physical property influenced by the field from the first fluid and communicating the particles together with the second fluid; and dividing the combined fluids.

The field forming unit includes electrodes electrically connected to a power source.

The power source includes an AC power source.

The power source includes a DC power source or includes a DC power source and an AC power source that are electrically connected with each other.

The electrodes are installed adjacent to a same edge of the flow channel in the width direction.

The electrodes are installed adjacent to a facing edge of the flow channel in the width direction, and a clearance is formed between the electrodes.

The clearance is arranged at one side of the flow channel in the width direction.

The clearance extends to one width-direction side of the flow channel and becomes narrow as it approaches the flow direction of the fluid.

One or both the electrodes are formed as cones.

The surface of the electrode has a slope with respect to the surface of the facing electrode.

The electrodes include protrusions protruded in the width direction of the flow channel.

The protrusions of different electrodes are alternately arranged, and the clearance between the protrusions is reduced as it goes to one width-direction edge of the flow channel.

The channel unit includes a plurality of inflow channels that are installed to be communicated to the flow channel on the opposite side to the side where the outflow channel is installed and receive the first fluid and the second fluid.

A protrusion crossing the flow channel in the width direction is formed at the electrode, and the protrusion is installed adjacent to the flow channel and the inflow channel for receiving the first fluid.

The field forming unit includes a magnet that is installed to be adjacent to the one width-direction edge of the flow channel and generates a magnetic field.

The field forming unit includes an electrode that is installed to be adjacent to the one width-direction edge of the flow channel and includes an electrode for generating a magnetic field.

An optical transmittable member of light transmitting material is installed in one width-direction edge of the flow channel, and a light source is installed adjacent to the optical transmittable member.

The particle separator includes a separating unit of greater than two stages that is communicate with one of the outflow channels, and separates and outputs the particles included in the fluid input from the outflow channel.

The flow channel has a junction at which the first fluid and the second fluid meet and a division point at which the first fluid and the second fluid are divided.

The field forming unit generates one or two of an electric field, a magnetic field, and an optical field.

The particles included in the first fluid are of a plurality of types, and different types of particles have different physical properties.

### ADVANTAGEOUS EFFECTS

According to the present invention, first, while flowing together, the first fluid and the second fluid move the particles having a predetermined physical property to the second fluid by a non-uniform field to thus easily separate the particles with the predetermined property.

Second, since the fields are not uniform fields that are not vertical to the moving direction of the fluid, it is possible to freely control the form and strength of the fields and freely control the particle's moving path, thereby efficiently separating various types of particles.

Third, since the particles are separated in the flowing process, the particles can be consecutively separated, and a large volume of particles can be easily separated.

Fourth, since the particles are separated with no direct contact with the particles, the particles are separated without any damage.

Fifth, various fields including the electric field, the magnetic field, and the optical field are applicable to the field for moving the particles, and hence, the particles having various properties can be efficiently separated.

Sixth, since the particle separator can have a multi-layered structure, it can separate many types of particles at once.

Seventh, when the field is an electric field, it is possible to configure the electrode structure in the triangle or cone form, form a field with a non-uniform electric field intensity, and easily move the particles to the second fluid by dielectrophoresis.

Eighth, the electrode forming the electric field includes a protrusion, and the particles can be efficiently separated by easily controlling the electric field intensity according to the protrusion's form and arrangement.

### BRIEF DESCRIPTION OF DRAWINGS

FIG. 1 is a brief perspective view of a particle separator according to a first exemplary embodiment of the present invention.

FIG. 2 is a schematic diagram of a process for separating particles by using a particle separator according to a first exemplary embodiment of the present invention.

FIG. 3 is a schematic diagram of a process for separating particles by using a particle separator according to a first exemplary embodiment of the present invention.

FIG. 4 is a picture of silver nano-particles output together with a second fluid when no power is supplied to a particle separator according to a first exemplary embodiment of the present invention.

FIG. 5 is a picture of silver nano-particles output together with a second fluid when a power is supplied to a particle separator according to a first exemplary embodiment of the present invention.

FIG. 6 is a schematic diagram of a particle separator according to a second exemplary embodiment of the present invention.

FIG. 7 is a schematic diagram of a particle separator according to a third exemplary embodiment of the present invention.

FIG. 8 is a schematic diagram of a particle separator according to a fourth exemplary embodiment of the present invention.

FIG. 9 is a schematic diagram of a particle separator according to a fifth exemplary embodiment of the present invention.

FIG. 10 is a schematic diagram of a particle separator according to a sixth exemplary embodiment of the present invention.

FIG. 11 is a schematic diagram of a particle separator according to a seventh exemplary embodiment of the present invention.

FIG. 12 is a schematic diagram of a particle separator according to an eighth exemplary embodiment of the present invention.

### MODE FOR THE INVENTION

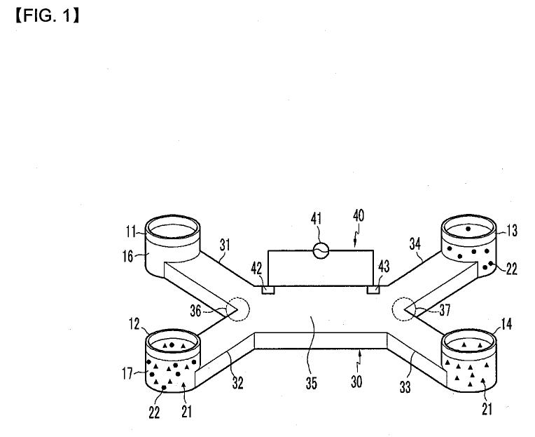

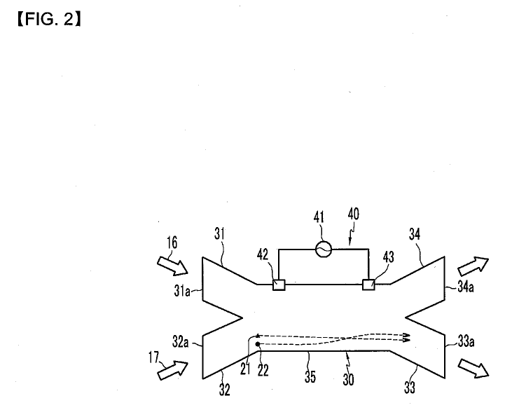

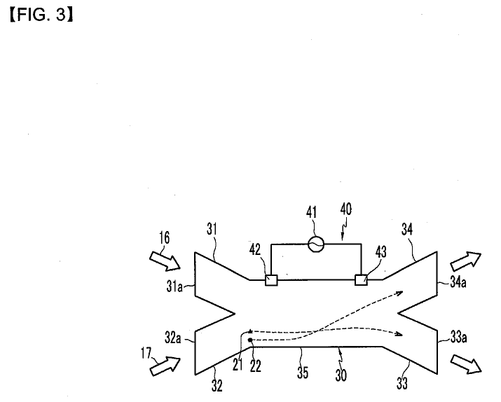

FIG. 1 is a brief perspective view for a particle separator according to a first exemplary embodiment of the present invention, and FIG. 2 and FIG. 3 are schematic diagrams for an operational principle of a particle separator according to a first exemplary embodiment of the present invention.

Referring to the drawings, the particle separator includes a channel unit 30 having a space in which a first fluid 17 in which different types of particles are mixed and a second fluid 16 that flows adjacent to the first fluid 17 are distributed. The particle separator further includes a field forming unit 40 that is installed adjacent to the channel unit 30 and forms a field for drawing part of the particles to the second fluid 16. The different types of particles have at least one different physical characteristic.

The field represents a space in which a predetermined influence for applying a physical stimulus to the particle is given, and it is defined to include an electric field, a magnetic field, an optical field, and an electromagnetic field. Also, the channel represents a path on which the particles move.

The channel unit 30 includes inflow units 31a and 32a for receiving the first fluid 17 and the second fluid 16, a flow channel 35 for distributing the first fluid 17 and the second fluid 16, and outflow units 33a and 34a for outputting fluids 17 and 16.

Also, the channel unit 30 includes an inflow channel 32 formed at one edge and receiving the first fluid 17, and an inflow channel 31 for receiving the second fluid 16. The inflow channels 31 and 32 are formed to be inclined with respect to the flow channel 35.

A combination point 36 is formed at the point where the inflow channels 31 and 32 meet the flow channel 35, and the fluids provided by the inflow channels 31 and 32 meet at the combination point 36.

The channel unit 30 includes outflow channels 33 and 34 that are formed at other edges and output the first fluid 17 and the second fluid 16, and a division point 37 for separating the first fluid 17 and the second fluid 16 is formed at the point where the outflow channels 33 and 34 meet. The division is defined in the embodiments of the present invention to include complete division of the first fluid 17 and the second fluid 16, and the case in which more than half of the first fluid 17 or the second fluid 16 is provided in the respective outflow channels 33 and 34 after passing through the division point 37.

The inflow channels 31 and 32 are connected to a vessel 12 for storing the first fluid 17 and a vessel 11 for storing the second fluid 16 so that the first fluid 17 and the second fluid 16 may be input, and the outflow channel 33 and 34 are connected to vessels 13 and 14 for respectively storing the divided first fluid 17 and the second fluid 16. The above-noted configuration is one example, and tubes other than the vessels can be connected to the inflow channels 31 and 32 and the outflow channels 33 and 34.

In the first fluid 17, different types of particles are mixed with the solvent that is a liquid medium, and the second fluid 16 includes liquid without particles.

The first fluid 17 and the second fluid 16 are liquid in the exemplary embodiment of the present invention, and the first fluid 17 and the second fluid 16 can be gas.

Also, the second fluid is exemplified as liquid without particles, and the second fluid can include particles if needed.

It is desirable to perform a laminar flow in the channel unit so that the first fluid 17 and the second fluid 16 may not be mixed. The Reynolds number must be small in order for the first fluid 17 and the second fluid 16 to perform a laminar flow, it is variable depending on the fluid type, speed, and flow path size, and it is reduced as the fluid speed is slower and the path size is smaller.

When the first fluid 17 and the second fluid 16 perform a laminar flow, the first fluid 17 and the second fluid 16 are not mixed, and the flow particles move in the flow direction together with the medium. The embodiment of the present invention is not restricted to this, and when the first fluid 17 and the second fluid 16 perform a turbulent flow, it is possible to move the particles to the second fluid 16 to increase the density of predetermined particles, and hence, the particle separator according to the embodiment of the present invention can be applied when the first fluid 17 and the second fluid 16 perform a turbulent flow and the fluids 16 and 17 are partially mixed.

The particles can be diffused at the boundary of the two fluids, and hence, more particles are diffused when the particles included in the first fluid 17 move to the second fluid 16 as the time used for moving from the combination point 36 to the division point 37 is increased.

Also, it is desirable to control the first fluid 17 and the second fluid 16 to be input to the flow channel 35 at the same speed. When the first fluid 17 and the second fluid 16 are input to the flow channel 35 at different speeds, turbulence is generated at the boundary of the first fluid 17 and the second fluid 16 so that the fluids 16 and 17 are easily mixed.

Therefore, a channel unit 30 according to the embodiment of the present invention is designed so that the fluid flowing into the channel unit 30 may perform a laminar flow to minimize the mixture of fluid and minimize the movement of particles caused by diffusion.

The flow channel 35 has a sufficiently large area compared to the particles, and hence, the cross-section of the flow channel 35 with respect to the fluid's flowing direction allows a plurality of particles. Therefore, a large volume of particles can be simultaneously separated to thus improve the process efficiency.

A field forming unit 40 for generating a field for moving the particles included in the first fluid 17 and the particles with a predetermined physical property to the second fluid 16 is installed in one width-direction edge of the flow channel 35. The field includes electric fields, and the field forming unit 40 includes a plurality of electrodes 42 and 43 for forming an electric field to the flow channel 35 and a power source 41 for applying the current to the electrodes 42 and 43. The power source 41 has an AC power source of a predetermined frequency. The power source includes a DC power source, or it includes a structure of the connected AC power source and DC power source.

The field forming unit 40 is installed at one width-direction edge of the flow channel 35 to form a non-uniform electric field in the width direction of the flow channel 35. That is, since the electrodes 42 and 43 are installed adjacent to the same edge in the width direction of the flow channel 35, the electric field formed at the one edge is stronger than that formed at the other edge.

The field includes a non-uniform electric field that is not vertical to the fluid's flow direction, and the non-uniform electric field generates dielectrophoresis to the particles to thus move the particles to the direction of the strong electric field intensity or the weak electric field intensity. When the non-uniform field is formed, the moving path of the particles can be freely controlled by controlling the intensity and form of the electric field.

The electrodes 42 and 43 are installed in the part where the second fluid 16 flows in order for the field forming unit 40 to move the particle performing positive dielectrophoresis to the second fluid 16. The electrodes 42 and 43 can be installed in the part where the first fluid 17 flows when the particle performing negative dielectrophoresis is moved to the second fluid 16.

The dielectrophoresis is to put the dielectric material provided in the medium into the non-uniform electric field and thus control the dielectric material to move in the direction of a greater or lesser gradient of the electric field.

The dielectrophoresis phenomenon is mainly used in the biological process for separating DNA or cells, and it has been recently used in the process of moving or assembling nano-scale material.

The positive dielectrophoresis represents a phenomenon in which material having polarizability greater than that of the medium moves to the part having greater electric field intensity. On the contrary, the negative dielectrophoresis represents a phenomenon in which material having polarizability lesser than that of the medium moves to the part having smaller electric field intensity. In this instance, the polarizability depends on the frequency of a voltage and dielectric constants of the solution and material.

The representative material that can be separated by the particle separator is carbon nanotubes.

The dielectric constant has a real part and an imaginary part, and the metallic carbon nanotubes have a very large real part and imaginary part. Regarding the semiconductive carbon nanotubes, the real part of the dielectric constant has a value near 1, and the imaginary part has a value of 0 or a small value depending on the condition in which the carbon nanotubes exist.

Accordingly, the metallic carbon nanotubes show positive dielectrophoresis in all the frequency bandwidths, and the semiconductor carbon nanotubes have a region having negative dielectrophoresis depending on the frequency.

The dielectrophoresis power of the semiconductor carbon nanotubes has a very small value compared to the metallic carbon nanotubes. Therefore, when the first fluid 17 in which the carbon nanotubes is well distributed to the flow channel 35 together with the second fluid 16, the non-uniform electric field generated with a predetermined frequency by the field forming unit 40 controls the metallic carbon nanotubes to move to the second fluid 16. Thus separate the metallic carbon nanotubes and the semiconductor carbon nanotubes.

In this instance, the used medium of the first fluid 17 includes a material that imparts no chemical or physical damage to the carbon nanotubes. When it is desired to generate predetermined molecules or a chemical reaction to change the carbon nanotubes, the carbon nanotubes can be separated after performing an appropriate chemical process, or a chemical process can be performed after separating the carbon nanotubes.

As shown in FIG. 2, when the first particle 22 performing positive dielectrophoresis and the second particle 21 rarely performing dielectrophoresis are included in the first fluid 17 and input to the flow channel 35, the first particle 22 is moved toward the second fluid 16 because of the non-uniform electric field. In this instance, when the power acting on the first particle 22 by the electric field is less than the speed of the fluid, the first particle 22 does not move to the second fluid 16 and remains in the first fluid 17 together with the second particle 21.

However, as shown in FIG. 3, when the power acting on the first particle 22 by the electric field is greater than the speed of the first fluid 17, the first particle 22 moves to the second fluid 16 from the first fluid 17, and the first particle 22 and the second particle 21 are output through different outflow units 33a and 34a.

According to the present exemplary embodiment, since desired particles are moved to the second fluid 16 and the particles can be separated while the first fluid 17 including different types of particles flow together with the second fluid 16, the particles with a predetermined property can be easily separated from among various particles.

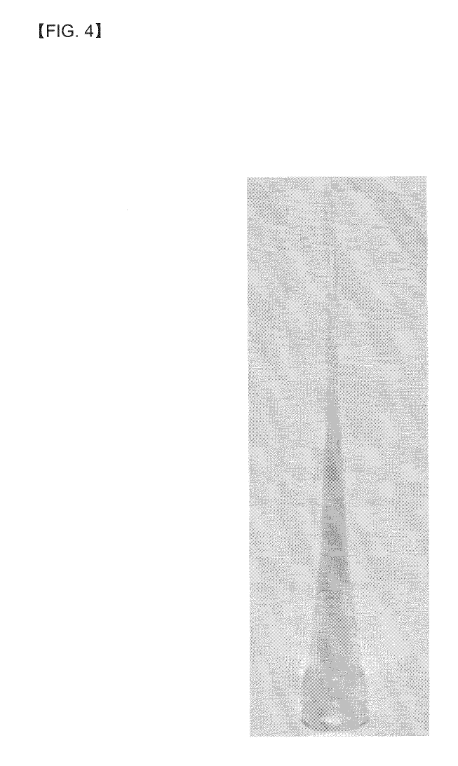

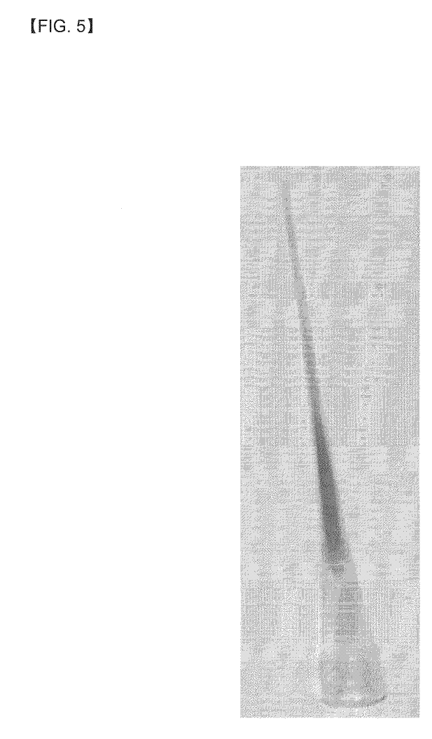

FIG. 4 and FIG. 5 are pictures showing experimental results of inputting the first fluid that is a solution including silver nano-particles to one inflow unit 32a and inputting water that is the second fluid to another inflow unit 31a.

When no power is supplied to the electrode, as shown in FIG. 4, a small amount of nano-particles are output to the outflow channel 34 together with the second fluid by diffusion. However, when the power is supplied thereto, the silver nano-particles are moved to the second fluid by the dielectrophoresis, and most of the silver nano-particles are output to the outflow channel 34 together with the second fluid as shown in FIG. 5.

The field forming unit forms the electric field to move the particles by dielectrophoresis in the exemplary embodiment, and without being restricted to this, the field forming unit can form fields such as a magnetic field, an optical field, and an electromagnetic field in addition to the electric field, and a plurality of fields.

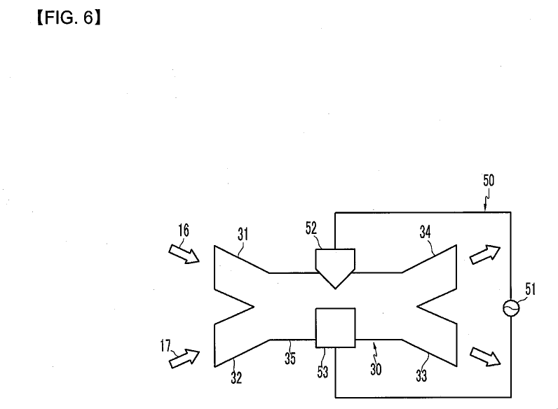

FIG. 6 is a schematic diagram for a particle separator according to a second exemplary embodiment of the present invention.

The particle separator includes a field forming unit 50 for generating electric fields, and the field forming unit 50 includes a power source 51 and electrodes 52 and 53 facing with each other in the width direction of the flow channel 35.

The electrodes 52 and 53 are installed at both edges of the flow channel 35 in the width direction, and the electrodes 52 and 53 are arranged with a gap therebetween so that the electric field may be formed between the electrodes 52 and 53. In this instance, the one electrode 52 has a wedge form facing the electrode 53. Also, the clearance is arranged beside one side of the width direction of the flow channel 35. When attempting to move the particles performing positive dielectrophoresis to the second fluid 16, the clearance is arranged in the direction in which the second fluid 16 flows.

In general, since the intensity of the electric field is strong in the narrow clearance between the electrodes 52 and 53, a relatively strong electric field is generated between the peak of the wedged electrode 52 and the electrode 53. Therefore, part of the particles included in the first fluid 17 move to the side with the strong intensity of electric field to be input to the second fluid 16 and thereby separate the particles.

When the electrode 52 is generated to have a wedged form, a strong electric field is generated at the peak so that the particles performing positive dielectrophoresis can be easily moved because of the difference between the neighboring region and the electric field.

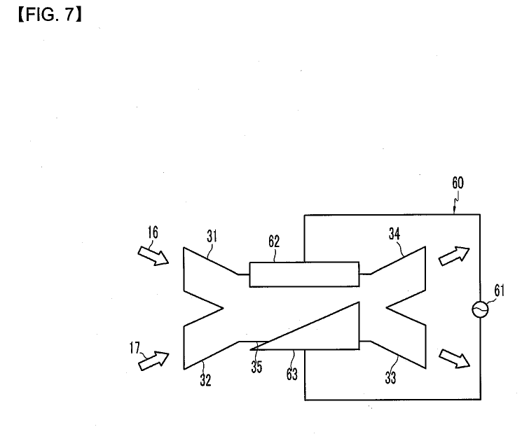

FIG. 7 is a schematic diagram for a particle separator according to a third exemplary embodiment of the present invention.

Referring to FIG. 7, the particle separator includes electrodes 62 and 63 installed in the width-direction edges of the flow channel 35, and a field forming unit 60 having a power source 61 electrically connected to the electrodes 62 and 63.

The side of the electrode 63 facing the electrode 62 slopes with reference to the electrode 62. A clearance between the electrodes 62 and 63 is reduced going the flow direction of the flow channel 35, and the clearance approaches the one width-direction edge of the flow channel 35 as it goes the flow direction.

When moving the particles performing positive dielectrophoresis to the second fluid 16, the clearance between electrodes 62 and 63 approach the second fluid 16, and when moving the particles performing negative dielectrophoresis to the second fluid 16, the clearance between the electrodes 62 and 63 can approach the first fluid 17.

The intensity of the electric field becomes greater as it goes the flow direction, and it becomes greater as it goes to the second fluid 16. Therefore, the particles performing positive dielectrophoresis from among the particles included in the first fluid 17 move to the second fluid 16 having great intensity of the electric field.

When the clearance between the electrodes 62 and 63 is reduced as it goes flow direction of fluids 16 and 17, the particles performing positive dielectrophoresis are forced in the direction of the second fluid 16 and in the flow direction simultaneously, and it can be progressed to the lower part and can be easily moved to the second fluid 16.

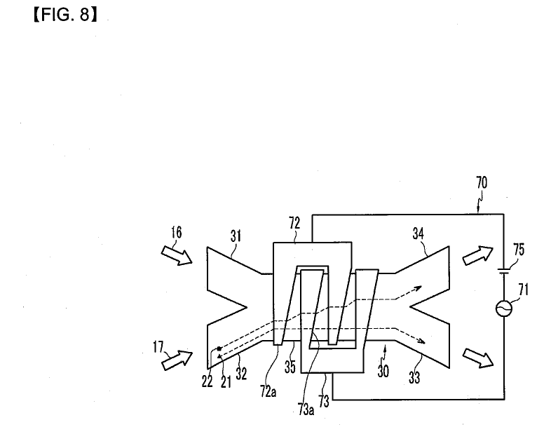

FIG. 8 is a schematic diagram for a particle separator according to a fourth exemplary embodiment of the present invention.

Referring to FIG. 8, the particle separator includes a channel unit 30 having two inflow channels 31 and 32, two outflow channels 33 and 34, and a flow channel 35 through which the second fluid 16 and the first fluid 17 are distributed.

Electrodes 72 and 73 having protrusions 72a and 73a are installed in both ends of the flow channel 35 in the width direction, and an AC power source 71 and a DC power source 75 coupled in series are installed in the electrodes 72 and 73.

The protrusions 72a and 73a formed on the electrodes 72 and 73 are alternately arranged, and in detail, the protrusion 73a of the electrode 73 installed near the other edge of the flow channel 35 is inserted between the protrusion 72a of the electrode 72 installed near the one edge thereof. The protrusions 72a and 73a are formed such that the side of the one protrusion 72a facing the other protrusion 73a slopes with respect to the facing side of the protrusion 73a so that the gap between the protrusions 72a and 73a may be reduced as the second fluid 16 approaches the edge of the flow channel 35.

Accordingly, the protrusions 72a and 73a become closer to each other as they go in the direction of the second fluid 16, and the intensity of the electric field formed between the protrusions 72a and 73a becomes greater as it goes to the second fluid 16. Therefore, the particles performing positive dielectrophoresis are moved to the second fluid 16 having a strong intensity of the electric field, the particles that are not influenced by the electric field flow following the first fluid 17, and hence, the particles with different properties can be separated.

The above-described configuration is an example for the case of moving the particles performing positive dielectrophoresis to the second fluid 16, and the case of moving the particles performing negative dielectrophoresis to the second fluid 16 has the configuration in which the gap between the protrusions 72a and 73a becomes narrow as it goes to the first fluid 17.

According to the embodiment, the gradient of the intensity of the electric field can be controlled in the width direction of the flow channel 35 by controlling the form and number of the protrusions 72a and 73a, and the particles are more easily moved to the second fluid 16.

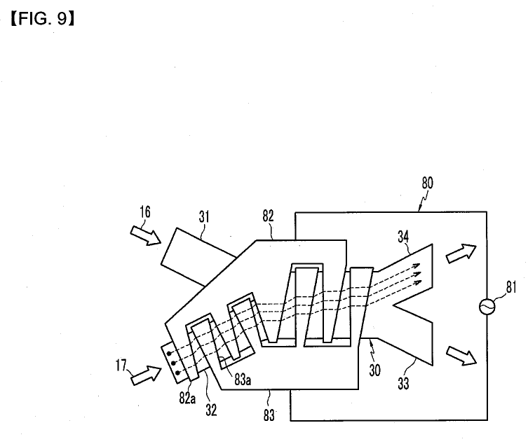

FIG. 9 is a schematic diagram for a particle separator according to a fifth exemplary embodiment of the present invention.

Referring to FIG. 9, the particle separator includes a channel unit 30 having inflow channels 31 and 32 for receiving a first fluid 17 and a second fluid 16, and a field forming unit 80 having electrodes 82 and 83 that are installed in both width-direction edges of the channel unit 30 and a power source 81 for supplying a current to the electrodes 82 and 83.

The electrodes 82 and 83 include a plurality of protrusions 82a and 83a, and the configurations of the protrusions 82a and 83a correspond to those according to the fourth exemplary embodiment of the present invention.

The electrodes 82 and 83 are extended to the inflow channel 32 as well as the flow channel 35 of the channel unit 30, and the protrusions 82a and 83a are installed in the inflow channel 32 for receiving the first fluid 17.

Therefore, the particles included in the first fluid 17 are influenced by the electric field from the inflow channel 32, and are gradually moved to the second fluid 16 while passing through the inflow channel 32.

When the first fluid 17 is applied into the flow channel 35, the particles having moved to the part where the second fluid 16 and the first fluid 17 meet are moved to the second fluid 16 by the electric field to be thus separated from other particles.

Accordingly, since the protrusions 82a and 83a can be installed from the inflow channel 32 and the particles can be moved to one side, the particles can be separated more quickly while the first fluid 17 and the second fluid 16 flow together. Therefore, the inflow of other particles to the second fluid 16 by diffusion can be minimized by reducing the contact time of the first fluid 17 and the second fluid 16.

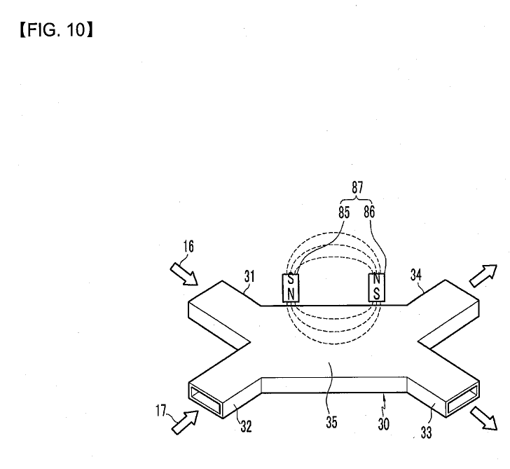

FIG. 10 is a schematic diagram for a particle separator according to a sixth exemplary embodiment of the present invention.

Referring to FIG. 10, the particle separator includes a field forming unit 87 for forming a magnetic field, and the field forming unit 87 includes a plurality of magnets 85 and 86 with a gap therebetween.

The magnets 85 and 86 are installed to be adjacent to the edge of the same side in the width direction of the flow channel 35 so that the gradient of the intensity of the magnetic field may be formed in the width direction of the flow channel 35.

Also, when the N polarity of the magnet 85 is installed to be near the flow channel 35, the S polarity of the magnet 86 is installed to be near the flow channel 35, and the different polarities of the magnets 85 and 86 are installed near the flow channel 35.

A magnetic field is generated between the N and S polarities near the flow channel 35, and the intensity of the magnetic field on the side where the magnet is installed is greater than that of the magnetic field on the side where the magnet is not installed.

Accordingly, when the second fluid 16 flows in the direction in which the magnet is installed and the first fluid 17 flows in the opposite direction, the particles moving in the direction of the large intensity of the magnetic field can be separated from the particles moving in the direction of the large intensity of the magnetic field and the particles that are not influenced by the magnetic field, by moving the particles moving in the direction of the large intensity of the magnetic field to the second fluid 16.

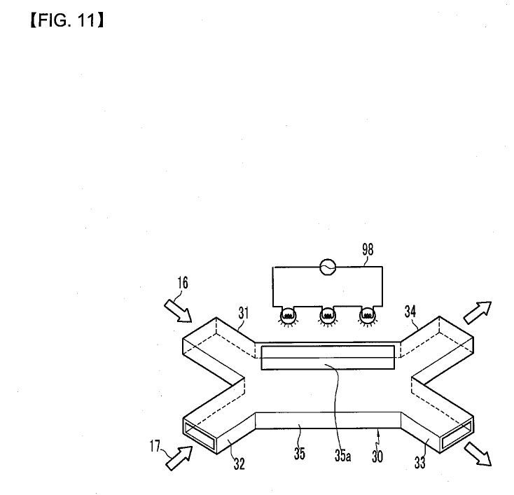

FIG. 11 is a schematic diagram for a particle separator according to a seventh exemplary embodiment of the present invention.

Referring to FIG. 11, the particle separator includes a channel unit 30 having inflow channels 31 and 32, outflow channels 33 and 34, and a flow channel 35 for distributing the first fluid 17 and the second fluid 16, and an optical transmittable member 35a for transmitting light is installed in one side of the flow channel 35.

The optical transmittable member 35a is installed in one edge of the flow channel 35 in the width direction so that the optical intensity of the light input in the width direction of the flow channel 35 may be different.

The optical transmittable member 35a is made of a transparent plate such as plastic or glass. The embodiment of the present invention is not restricted to this, and the optical transmittable member 35a also includes a transparent film and light transmitting material.

A field forming unit 98 for applying light to the optical transmittable member 35a is installed near the flow channel 35. The field forming unit 98 includes a light source and a power source for supplying the current to the light source, and forms optical fields around the flow channel 35.

The field forming unit 98 is installed to be adjacent to one width-direction edge of the flow channel 35 so that the light with different intensities may be applied in the width direction of the flow channel 35. When attempting to separate the particles that move to the side with the greater optical intensity by moving the particles to the second fluid 16, the field forming unit 98 is installed in the edge of the part in which the second fluid 16 flows, and when attempting to separate the particles that move to the side with the lesser optical intensity by moving the particles to the second fluid 16, the field forming unit 98 can be installed in the part in which the first fluid 17 flows.

Accordingly, the particle separator can separate the particles that move according to the light intensity by moving the particles to another side from other particles when the optical transmittable member 35a and the field forming unit 98 for applying light to the optical transmittable member 35a are used.

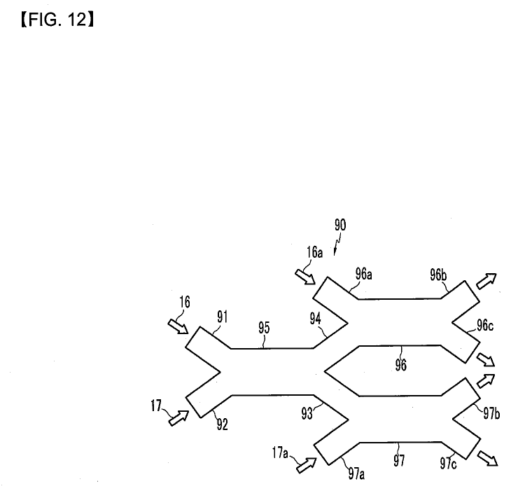

FIG. 12 is a schematic diagram for a particle separator according to an eighth exemplary embodiment of the present invention.

Referring to the drawing, the particle separator 90 has a plurality of stages for separating the particles. The particle separator 90 includes a first separating unit 95 in which the adjacent first fluid 17 and second fluid 16 flow, first inflow channels 91 and 92 that are installed at one edge of the first separating unit 95 and respectively receive the first fluid 17 and the second fluid 16, and first outflow channels 93 and 94 that are formed at another edge of the first separating unit 95 and output the first fluid 17 and the second fluid 16.

The particle separator 90 further includes a second separating unit 96 and a third separating unit 97 that are respectively connected to the first outflow channels 93 and 94 outputting the fluids having passed the first separating unit 95.

That is, the first separating unit 95 includes two first inflow channels 91 and 92 and two first outflow channels 93 and 94, and each of the first outflow channels 93 and 94 is connected to the second separating unit 96 and the third separating unit 97.

The first fluid 17 and the second fluid 16 are input to the first separating unit 95 through the inflow channels 91 and 92, and part of the particles included in the first fluid 17 are moved to the second fluid 16 by the electric field while passing through the first separating unit 95.

The second fluid 16 including the separated particles is input to the second separating unit 96 through the first outflow channel 94, and the first fluid 17 including other particles is input to the third separating unit 97 through the first outflow channel 93.

The second separating unit 96 includes a second inflow channel 96a for receiving the third fluid 16a, and two second outflow channels 96b and 96c. The second fluid 16 input through the first outflow channel 94 transmits part of the particles included in the second fluid 16 to the third fluid 16a by the electric field while passing through the second separating unit 96 together with the third fluid 16a. The second fluid 16 is output to the second outflow channel 96c, and the third fluid 16a is output to the second outflow channel 96b.

The third separating unit 97 includes a third inflow channel 97a for receiving the fourth fluid 16b, and two third outflow channels 97b and 97c. The first fluid 17 input through the first outflow channel 93 is passed through the third separating unit 97 together with the fourth fluid 16b, and transmits part of the particles included in the first fluid 17 to the fourth fluid 16b by the electric field. The first fluid 17 is output to the third outflow channel 97c and the fourth fluid 16b is output through the third outflow channel 97b.

Accordingly, the particle separator 90 has a plurality of separating units 95, 96, and 97 that are connected by multiple stages so that the respective particles can be separated once by the particle separator 90 when the different particles of more than three are included in the first fluid 17.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A particle separator comprising:
a channel unit including a flow channel through which a first fluid having particles with at least one physical characteristic and a second fluid that flows near the first fluid flow and does not have particles, and a plurality of outflow channels that are connected from the flow channel and separate the fluid having passed the flow channel; and
a field forming unit, installed adjacent to the flow channel, for separating the particles from the first fluid and generating a non-uniform field so that the particles flow together with the second fluid,
wherein the field forming unit includes electrodes electrically connected to a power source, wherein the electrodes are installed adjacent to edges of the same side of the flow channel in the width direction.

2. (canceled)

3. (canceled)

4. (canceled)

5. (canceled)

6. A particle separator comprising:
a channel unit including a flow channel through which a first fluid having particles with at least one physical characteristic and a second fluid that flows near the first fluid flow, and a plurality of outflow channels that are connected from the flow channel and separate the fluid having passed the flow channel; and
a field forming unit, installed adjacent to the flow channel, for separating the particles from the first fluid and generating a non-uniform field so that the particles flow together with the second fluid,
wherein the field forming unit includes electrodes electrically connected to a power source, the electrodes are installed adjacent to a facing edge of the flow channel in the width direction, and a clearance is formed between the electrodes, the electrodes include protrusions protruded in the width direction of the flow channel.

7. The particle separator of claim 6, wherein
the particles included in the first fluid are made of a plurality of types of particles, each type of particles has a physical characteristic that differ from other types.

8. (canceled)

9. The particle separator of claim 6, wherein
one or both the electrodes are formed as wedge shape.

10. The particle separator of claim 6, wherein
the surface of the electrode has a slope with respect to the surface of the facing electrode.

11. (canceled)

12. The particle separator of claim 11, wherein
the protrusions of different electrodes are alternately arranged, and the clearance between the protrusions is reduced as it goes to one width-direction edge of the flow channel.

13. The particle separator of claim 1, wherein
the channel unit includes a plurality of inflow channels that are installed to be communicated with the flow channel on the opposite side of the side where the outflow channel is installed and that receive the first fluid and the second fluid.

14. The particle separator of claim 13, wherein
a protrusion crossing the flow channel in the width direction is formed at the electrode, and the protrusion is installed adjacent to the flow channel and the inflow channel for receiving the first fluid.

15. (canceled)

16. (canceled)

17. A particle separator comprising:
a channel unit including a flow channel through which a first fluid having particles with at least one physical characteristic and a second fluid that flows near the first fluid flow, and a plurality of outflow channels that are connected from the flow channel and separate the fluid having passed the flow channel; and
a field forming unit, installed adjacent to the flow channel, for separating the particles from the first fluid and generating a non-uniform field so that the particles flow together with the second fluid,
an optical transmittable member of a light transmitting material which is installed in one width-direction edge of the flow channel, and
a light source which is installed adjacent to the optical transmittable member.

18. A particle separator comprising:
a channel unit including a flow channel through which a first fluid having particles with at least one physical characteristic and a second fluid that flows near the first fluid flow, and a plurality of outflow channels that are connected from the flow channel and separate the fluid having passed the flow channel; and
a field forming unit, installed adjacent to the flow channel, for separating the particles from the first fluid and generating a non-uniform field so that the particles flow together with the second fluid,
wherein the particle separator includes a separating unit of greater than two stages that is communicated with one of the outflow channels, and that separates and outputs the particles included in the fluid input from the outflow channel.

19. The particle separator of claim 1, wherein
the flow channel has a junction at which the first fluid and the second fluid meet and a division point at which the first fluid and the second fluid are divided.

20. (canceled)

21. (canceled)

22. A particle separating method comprising:
combining a first fluid including particles with at least one physical characteristic and a second fluid that flows adjacent to the first fluid;
generating a field for applying a physical force to the first fluid and the second fluid that flow together;
separating the particles having the physical property influenced by the field from the first fluid and flowing the particles together with the second fluid; and
dividing the combined fluids.

23. The particle separating method of claim 22, wherein
the field is formed by one of a magnetic field, an electric field, an electromagnetic field, and an optical field, or a combination thereof.

24. The particle separating method of claim 22, wherein
the first fluid and the second fluid flow according to a laminar flow.

25. The particle separating method of claim 22, wherein
The first fluid and the second fluid are flow same velocity.

26. The particle separating method of claim 22, wherein
the field is formed by optical field which generating light.

27. The particle separating method of claim 22, wherein
the first fluid have plurality of types of particles, the second fluid before combining with the first fluid have no particle.
